(19) United States
(12) Patent Application Publication
(10) Pub. No.: US 2011/0294645 A1
(43) Pub. Date: Dec. 1, 2011

(54) APPARATUS AND METHOD FOR MANUFACTURING FLOAT GLASS

(76) Inventors: Woo-Hyun KIM, Dongducheon-si (KR); Sang-Oeb Na, Seoul (KR); Won-Jae Moon, Seoul (KR); Jeong-Deok Kim, Seoul (KR); Kil-Ho Kim, Suwon-si (KR); Heui-Joon Park, Paju-si (KR); Jin Han, Goyang-si (KR); Dong-Shin Shin, Bupyeong-gu (KR)

(21) Appl. No.: 13/149,099

(22) Filed: May 31, 2011

(30) Foreign Application Priority Data
Jun. 1, 2010 (KR) 10-2010-0051987

(51) Int. Cl. C03B 18/16; C03C 3/00; C03B 18/02

(52) U.S. Cl. 501/11; 65/182.3; 65/99.2

(57) ABSTRACT

An apparatus for manufacturing a float glass includes a bottom block in which molten metal is stored to float, a loop block which covers the bottom block, and a shield for preventing a vapor, which is generated from the molten metal at both sides of the bottom block, from advancing toward the molten glass or for keeping a circumstance above the molten glass.

### CROSS-REFERENCE TO RELATED APPLICATION

This application claims priority under 35 U.S.C. §119(a) to Korean Patent Application No. 10-2010-0051987 filed at the Korean Intellectual Property Office on Jun. 1, 2010, the entire contents of which are incorporated herein by reference.

### BACKGROUND

1. Field

Exemplary embodiments relate to an apparatus and method for manufacturing a float glass, and more particularly, to an apparatus and method for manufacturing a float glass, which has an improved structure so that metal vapor volatilizing from molten metal in a float chamber is not moved toward a glass ribbon.

2. Description of the Related Art

Generally, flat glasses used in the industries such as window panes (e.g., soda lime silica glasses) of vehicles or buildings are mostly produced using a floating process well known in the art. In addition, thin glass panes or glass films (e.g., non-alkali glasses) for TFT displays or the like are also a kind of “float glass” produced using a floating process.

FIG. 1 is a sectional view schematically showing a general float glass manufacturing system.

Referring to FIG. 1, a general float glass manufacturing system 2 includes, for example, a float chamber 1 for sealing reducing hydrogen (H₂) and/or nitrogen (N₂) gas to be fully filled therein so as to prevent molten metal M from being oxidized. In other words, the float chamber 1 includes a bottom block 6, a loop block 7 positioned above the bottom block 6, and a side seal 8 installed between the bottom block 6 and the loop block 7. The side seal 8 has a venting hole 8a.

Meanwhile, the loop block 7 includes a loop brick layer composed of a plurality of refractory bricks in which a plurality of heaters 9 are installed. The heaters 9 keep the inside of the float chamber 1 at a predetermined temperature.

However, in the general float glass manufacturing system 2, if the molten metal M containing tin floating in the float chamber 1 reacts with oxygen existing in the float chamber 1, the molten metal M is evaporated into tin oxide (e.g., SnO). If the tin oxide is condensed and reduced, metal tin is created and falls down onto the surface of molten glass G, which results in defects of a finally produced float glass. Therefore, the need to control the creation of such crystals in order to produce a high quality float glass is in demand.

### SUMMARY

The exemplary embodiments are designed to solve the problems of the prior art, and therefore the exemplary embodiments are directed to providing an apparatus and method for manufacturing a float glass with an improved structure which may control metal (tin) vapor, volatilizing from a free end of molten metal which is not covered by molten glass, to not move toward a glass ribbon.

In one aspect, the exemplary embodiment provides an apparatus for manufacturing a float glass, including: a bottom block in which molten metal is stored to float; a loop block which covers the bottom block; and a shield for preventing a vapor, which is generated from the molten metal at both sides of the bottom block, from advancing toward the molten glass or for keeping a circumstance above the molten glass.

Preferably, the shield is disposed to hang from the loop block in a length direction of the loop block in correspondence with an edge of the molten glass.

Preferably, the shield has an end spaced apart from a surface of the molten metal by a predetermined distance.

Preferably, the shield includes refractory material.

Preferably, the refractory material is alumina-based or silica-based material.

Preferably, the refractory material includes sillimanite-based refractory bricks.

The apparatus for manufacturing a float glass according to the exemplary embodiment may further include a cooler included in the shield.

Preferably, the cooler includes a tube in which a coolant is stored.

In another aspect, the exemplary embodiment provides a method for manufacturing a float glass, including: continuously supplying molten glass onto the molten metal from an inlet of a float chamber of the apparatus for manufacturing a float glass according to the above embodiment; forming the molten glass into a glass ribbon on the molten metal; and continuously drawing the glass ribbon from an outlet of the float chamber.

The apparatus and method for manufacturing a float glass according to exemplary embodiments prevent tin vapor volatilizing from molten metal from moving toward a glass ribbon by installing a shield at the top of the surface of the molten metal in a length direction of a float chamber. Therefore, the apparatus and method may fundamentally prevent a finally produced float glass from being defected by tin oxide.

### BRIEF DESCRIPTION OF THE DRAWINGS

Other objects and aspects of the present invention will become apparent from the following descriptions of the embodiments with reference to the accompanying drawings in which:

FIG. 1 is a sectional view schematically showing a general float glass manufacturing system;

FIG. 2 is an exploded perspective view schematically showing an apparatus for manufacturing a float glass according to an exemplary embodiment;

FIG. 3 is a sectional view showing the apparatus of FIG. 2;

FIG. 4 is a sectional view showing a modification of a shield of FIG. 2.

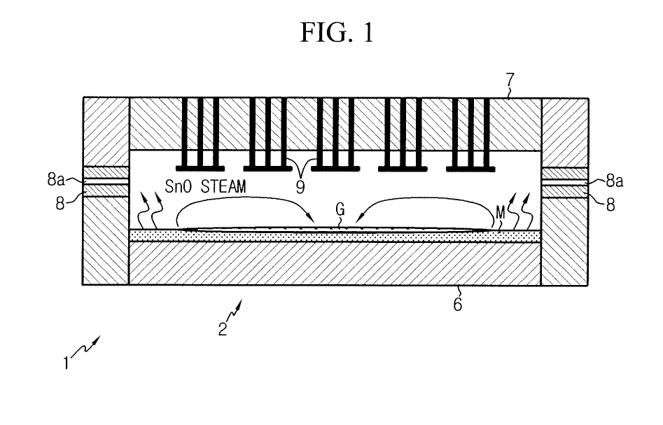

### DESCRIPTION OF THE PREFERRED EMBODIMENT

Hereinafter, an apparatus and method for manufacturing a float glass according to exemplary embodiments will be described in detail with reference to the accompanying drawings.

Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

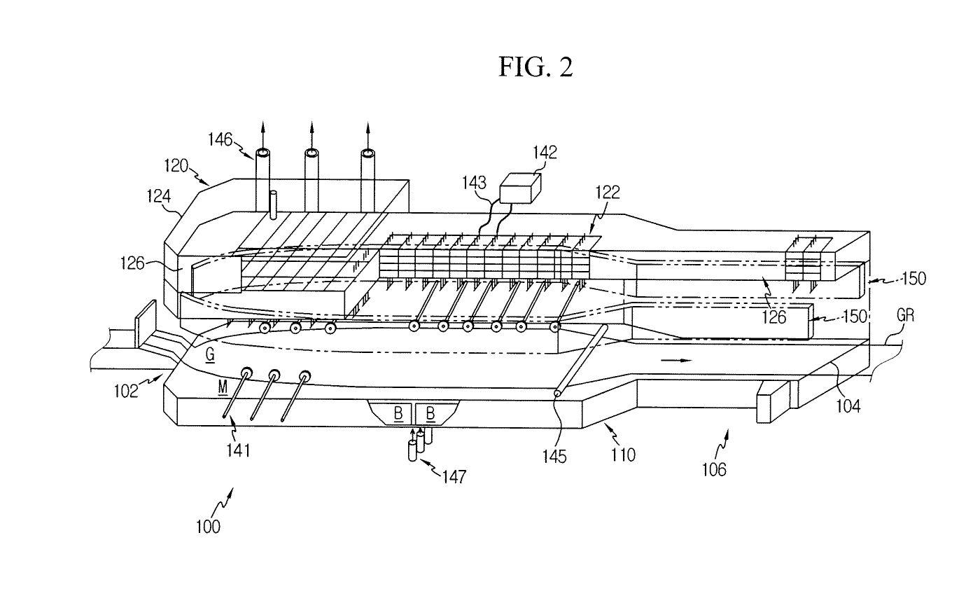

FIG. 2 is an exploded perspective view schematically showing an apparatus for manufacturing a float glass according to an exemplary embodiment, and FIG. 3 is a sectional view showing the apparatus of FIG. 2.

Referring to FIGS. 2 and 3, the apparatus 100 for manufacturing a float glass according to this embodiment includes a bottom block 110 in which molten metal M is filled and floats, a loop block 120 positioned above the bottom block 110 to cover the bottom block 110, and a side seal 130 interposed between the loop block 120 and the bottom block 110.

The bottom block 110, the loop block 120 and the side seal 130 configure a sealed float chamber 106 with an inlet 102 and an outlet 104 as a whole. The inside of the float chamber 106 is filled with a mixed gas of nitrogen and hydrogen. The mixed gas is kept at a pressure slightly higher than the atmospheric pressure. The molten metal M and ribbon-shaped molten glass G are kept at about 600 to 1,300° C. by a heater 122 installed in a brick layer of the loop block 120. The molten glass G is a non-alkali glass, a soda lime glass or the like. The principle or structure of generating a flow of the molten metal M in the float chamber 106 and the process of putting, forming into a ribbon shape, moving or discharging the molten glass G are already well known in the art as a floating process, and they are not described in detail here. Reference numeral 141 represents a top-roller for forming the molten glass G. Reference numeral 142 represents a transformer for supplying and/or controlling power to the heater 122. Reference numeral 143 represents a bus bar which electrically connects the transformer 142 to the heater 122. Reference numeral 145 represents a tin barrier for controlling a floating direction of the molten metal M. Reference numeral 146 represents a venting system for discharging the gas in the float chamber 106 to the outside. Reference numeral 147 represents a cooling member for cooling the bottom block 110.

The bottom block 110 is composed of plural bricks B arranged in a length direction of the float chamber 106 so that molten metal M such as a molten tin, a molten tin alloy or the like may be stored thereon. The bricks B are surrounded by a metal casing (not shown).

The side seals 130 are located at the upper surface of the bottom block 110 and the lower surface of the loop block 120 to seal the float chamber 106 by substantially isolating the inside of the float chamber 106 from the outside. The side seals 130 are a plurality of structures with a substantially hexahedral shape, which are adjacently arranged in a length direction of the float chamber 106. The side seals 130 may have discharge holes 134 at several locations so that the discharge holes 134 communicate with the venting system 146.

The loop block 120 includes a steel loop casing 124 which hangs from an upper structure (not shown) such as a crossbeam in a building to which the float chamber 106 is installed, and a side block 126 which is made of lining heat-retaining bricks and disposed in a lower space of the loop casing 124. The inner space of the loop block 120 is divided into an upper space and a lower space by a loop brick layer.

The float chamber 106 according to the exemplary embodiment includes a shield 150 for preventing the metal (tin) oxide, generated at the surface of the molten metal M, namely at the surface of the molten metal M not covered by the molten glass G, from advancing toward the molten glass G and also for preventing the circumstance on the molten glass G from moving toward the side seals 130, namely to both sides of the float chamber 106 from an advancing direction of the molten glass G.

The shield 150 is installed to hang from the loop block 120 in correspondence with an edge portion of the molten glass G and is arranged continuously or discontinuously in a length direction of the float chamber 106. In addition, it is preferred that the shields 150 are symmetrically installed at both sides of the float chamber 106 so as not to interfere with other components installed at both sides of the float chamber 106, such as top-rollers 141. In addition, as described above, the upper end of the shield 150 is installed to hang from the lower end of the brick layer of the loop block 120, and the lower end of the shield 150 corresponding to the upper end is disposed spaced apart from the surface of the molten metal M by a predetermined distance.

The shield 150 is made of the same material as the loop block 120, for example alumina-based or silica-based refractory material. More preferably, the shield 150 includes sillimanite-based refractory bricks.

As shown in FIG. 3, the shield 150 substantially divides the inner space of the float chamber 106 into three regions. In other words, the inner space of the float chamber 106 is divided by two shields 150 installed at both sides into a center space 105 which keeps a circumstance necessary for forming a glass, and side spaces 107 from which tin oxide of the molten metal M may discharge out through the side seals 130. Therefore, in the center space 105 of the float chamber 106, the tin oxide substantially does not evaporate from the surface of the molten metal M since the molten glass G substantially covers the entire surface of the molten metal M. In addition, the shields 150 prevent the tin oxide existing in side spaces 107 at both sides from penetrating into the center space 105.

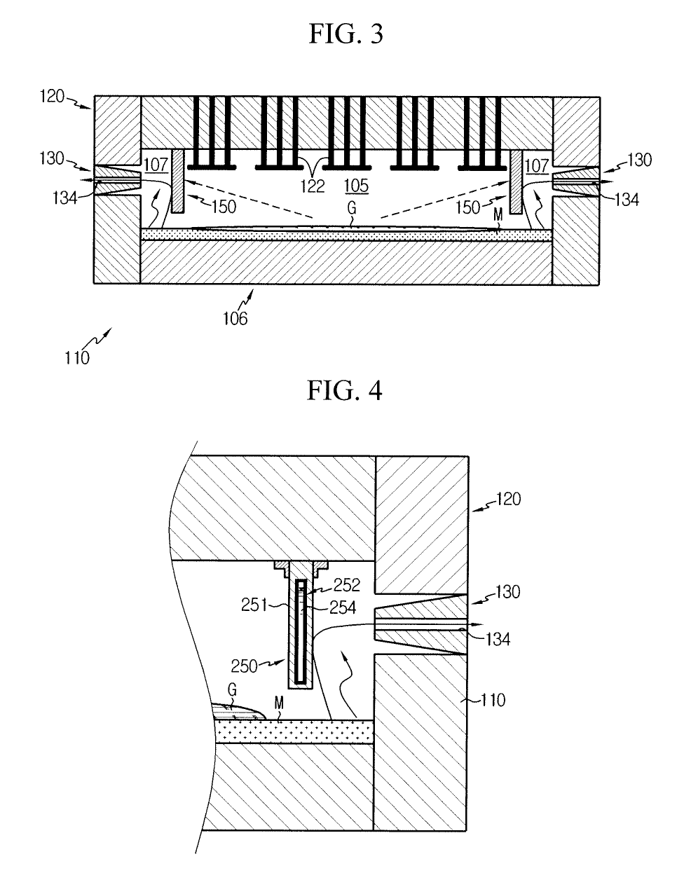

FIG. 4 is a sectional view showing a shield according to another exemplary embodiment.

Referring to FIG. 4, a shield 250 of this embodiment has a tube structure which includes a shield body 251 composed of refractory bricks, a cooler 252 installed in the shield body 251, and a coolant 254 such as water stored in the cooler 252. In this embodiment, when the shield 250 is heated by the high-temperature circumstance in the float chamber 106, the cooler 252 is separately provided in the shield 250 so as to cool the shield 250. The cooler 252 may include cooling units other than a tube, and the coolant 254 stored in the tube may be cooling materials other than water, as apparent to those of ordinary skill in the art.

According to a method for manufacturing a float glass according to an exemplary embodiment, the apparatus 100 for manufacturing a float glass according to the above embodiments is used to manufacture a glass with a forming temperature of 600 to 1,300° C. by a float process. In other words, molten glass G has a lower viscosity than molten metal M, and the weight of the molten glass G is about ⅔ of that of the molten metal M. The molten glass G is continuously supplied into the apparatus 100 through the inlet 102 of the float chamber 106 and then advances to the downstream side of the float chamber 106 while floating and spreading on the molten metal M. In this process, the molten glass G reaches an equivalent thickness according to its surface tension and the gravity so that a glass strip or ribbon GR which is solidified to some extent is formed. The glass ribbon GR is drawn by lift-out rollers (not shown) adjacent to the outlet 104 of the float chamber 106 and is pulled toward an annealing lehr (not shown). In addition, the thickness of the produced glass ribbon GR may be changed according to the amount of molten glass G put through the inlet 102 or the pulling speed determined by a rotating speed of the lift-rollers or when forming means such as the top-rollers 141 installed in the float chamber 106 is controlled or changed. Therefore, the apparatus 100 for manufacturing a float glass according to this embodiment may perform a circulating process endlessly and operate on a permanent basis. In fact, the apparatus 100 according to this embodiment may manufacture a float glass without cessation over several years. Here, the drawing speed of the glass ribbon GR would be generally 1 to 200 ton/day. In this process, the tin oxide generated from the surface of the molten metal M not covered by the molten glass G is intercepted by the shield 150 not to penetrate into the center region of the float chamber 106 in the length direction. Therefore, the tin oxide does not settle on the surface of the glass ribbon, which may improve the quality of the products finally produced.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An apparatus for manufacturing a float glass, comprising:
a bottom block in which molten metal is stored to float;
a loop block which covers the bottom block; and
a shield for preventing vapor, which is generated from the molten metal at both sides of the bottom block, from advancing toward the molten glass or for keeping a circumstance above the molten glass.

2. The apparatus for manufacturing a float glass according to claim 1, wherein the shield is disposed to hang from the loop block in a length direction of the loop block in correspondence with an edge of the molten glass.

3. The apparatus for manufacturing a float glass according to claim 1, wherein the shield has an end spaced apart from a surface of the molten metal by a predetermined distance.

4. The apparatus for manufacturing a float glass according to claim 1, wherein the shield includes refractory material.

5. The apparatus for manufacturing a float glass according to claim 4, wherein the refractory material is alumina-based or silica-based material.

6. The apparatus for manufacturing a float glass according to claim 5, wherein the refractory material includes sillimanite-based refractory bricks.

7. The apparatus for manufacturing a float glass according to claim 1, further comprising a cooler included in the shield.

8. The apparatus for manufacturing a float glass according to claim 7, wherein the cooler includes a tube in which a coolant is stored.

9. A method for manufacturing a float glass, comprising:
continuously supplying molten glass onto the molten metal from an inlet of a float chamber of the apparatus for manufacturing a float glass according to claim 1;
forming the molten glass into a glass ribbon on the molten metal; and
continuously drawing the glass ribbon from an outlet of the float chamber.

10. A float glass manufactured by the method according to claim 9.
